(19) United States
(12) Patent Application Publication
(10) Pub. No.: US 2017/0212581 A1
(43) Pub. Date: Jul. 27, 2017

(54) SYSTEMS AND METHODS FOR PROVIDING POWER EFFICIENCY VIA MEMORY LATENCY CONTROL

(71) Applicant: QUALCOMM INCORPORATED, SAN DIEGO, CA (US)

(72) Inventors: Hee Jun Park, San Diego, CA (US); Richard Stewart, San Diego, CA (US)

(21) Appl. No.: 15/005,534

(22) Filed: Jan. 25, 2016

(51) Int. Cl. G06F 1/32; G06F 13/40; G06F 13/16; G06F 1/28; G06F 12/08

(52) U.S. Cl. CPC G06F 1/3296; G06F 1/28; G06F 12/0802; G06F 13/16; G06F 13/4068; G06F 2212/1021

(57) ABSTRACT

Systems, methods, and computer programs are disclosed for controlling power efficiency in a multi-processor system. The method comprises determining a core stall time due to memory access for one of a plurality of cores in a multi-processor system. A core execution time is determined for the one of the plurality of cores. A ratio of the core stall time versus the core execution time is calculated. The method dynamically scales a frequency vote for a memory bus based on the ratio of the core stall time versus the core execution time.

### DESCRIPTION OF THE RELATED ART

Portable computing devices (e.g., cellular telephones, smart phones, tablet computers, portable digital assistants (PDAs), portable game consoles, wearable devices, and other battery-powered devices) and other computing devices continue to offer an ever-expanding array of features and services, and provide users with unprecedented levels of access to information, resources, and communications. To keep pace with these service enhancements, such devices have become more powerful and more complex. Portable computing devices now commonly include a system on chip (SoC) comprising a plurality of memory clients embedded on a single substrate (e.g., one or more central processing units (CPUs), a graphics processing unit (GPU), digital signal processors, etc.). The memory clients may read data from and store data in a memory system electrically coupled to the SoC via a memory bus.

The energy efficiency and power consumption of such portable computing devices may be managed to meet performance demands, workload types, etc. For example, existing methods for managing power consumption of multiprocessor devices may involve dynamic clock and voltage scaling (DCVS) techniques. DCVS involves selectively adjusting the frequency and/or voltage applied to the processors, hardware devices, etc. to yield the desired performance and/or power efficiency characteristics. Furthermore, a memory frequency controller may also adjust the operating frequency of the memory system to control memory bandwidth.

Busy time in processing cores comprises two main components: (1) a core execution time in which a processing core actively executes instructions and processes data; and (2) a core stall time in which the processing core waits for data read/write in memory in case of a cache miss. When there are many cache misses, the processing core waits for memory read/write access, which increases the core stall time due to memory access. An increased stall time percentage significantly decreases energy efficiency. As known in the art, the power overhead penalty depends on various factors, including, the types of processing cores, the operating frequency, temperature, and leakage of the cores, and the stall time duration and/or percentage. Existing energy efficiency solutions pursue the lowest operating frequency in memory based on the processing core(s) bandwidth voting.

Existing solutions may reduce execution time by increasing the operating frequency of the processing core, but this does not address core stall time. The core stall time may be reduced by increasing the operating frequency of the memory bus (shorter cache misses and refill overhead) or by increasing the size of the cache (reducing cache misses). However, these approaches do not address core execution times.

Accordingly, there is a need for improved systems and methods for controlling power efficiency in a multi-processor system.

### SUMMARY OF THE DISCLOSURE

Systems, methods, and computer programs are disclosed for controlling power efficiency in a multi-processor system. The method comprises determining a core stall time due to memory access for one of a plurality of cores in a multi-processor system. A core execution time is determined for the one of the plurality of cores. A ratio of the core stall time versus the core execution time is calculated. A frequency vote for a memory bus is dynamically scaled based on the ratio of the core stall time versus the core execution time.

Another embodiment is a system comprising a dynamic random access memory (DRAM) and a system on chip (SoC) electrically coupled to the DRAM via a double data rate (DDR) bus. The SoC comprises a plurality of processing cores, a cache, and a DDR frequency controller. The DDR frequency controller is configured to dynamically scale a frequency vote for the DDR bus based on a calculated ratio of a core stall time versus a core execution time for one of the plurality of processing cores.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for controlling power efficiency in a multi-processor system based on a ratio of the core stall time versus the core execution time.

FIG. 2 is a combined flow/block diagram illustrating the operation of the resource power manager (RPM) of FIG. 1.

FIG. 3 illustrates two exemplary workload types with different ratios of core stall time versus execution time.

FIG. 4 is flowchart illustrating an embodiment of a method for controlling power efficiency in the system of FIGS. 1 and 2 based on the ratio of the core stall time versus the core execution time.

FIG. 5 is a table illustrating exemplary control actions that may be executed based on the ratio of the core stall time versus the core execution time.

FIG. 6a is a combined block/flow diagram illustrating an embodiment of the DDR frequency controller of FIG. 1.

FIG. 6b illustrates another embodiment of the functional scaling blocks in FIG. 6a.

FIG. 7 is a combined block/flow diagram illustrating another embodiment of a heterogeneous core architecture for implementing memory frequency control based on the ratio of the core stall time versus the core execution time.

FIG. 8 is a block diagram of an embodiment of a portable communication device for incorporating the system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

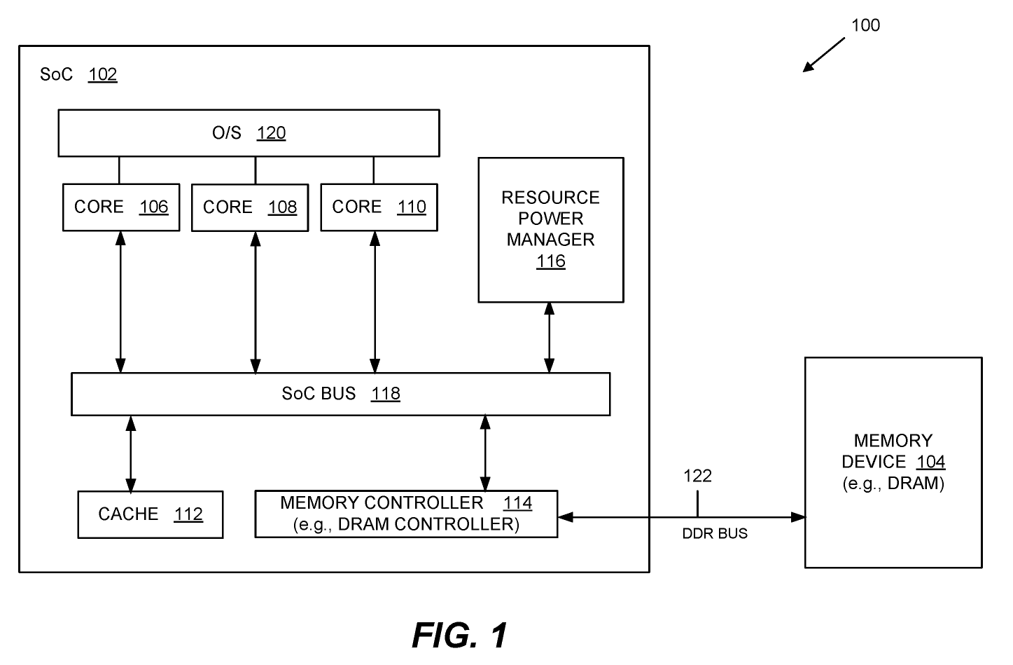

FIG. 1 illustrates an embodiment of a system 100 for controlling power efficiency via memory latency control in a multi-processor system. The system 100 may be implemented in any computing device, including a personal computer, a workstation, a server, or a portable community device (PCD), such as a cellular telephone, a smart phone, a portable digital assistant (PDA), a portable game console, a tablet computer, or a battery-powered wearable device.

As illustrated in FIG. 1, the system 100 comprises a system on chip (SoC) 102 electrically coupled to a memory system via a memory bus. In the embodiment of FIG. 1, the memory system comprises a memory device (e.g., a dynamic random access memory (DRAM) 104) coupled to the SoC 102 via a memory bus (e.g., a double data rate (DDR) bus 122). The SoC 102 comprises various on-chip components, including a plurality of processing cores 106, 108, and 110, a DRAM controller 114 (or memory controller for any other type of memory), a cache 112, and a resource power manager (RPM) 116 interconnected via a SoC bus 118.

Each processing core 106, 108, and 110 may comprise one or more processing units (e.g., a central processing unit (CPU), a graphics processing unit (GPU), a digital signal processor (DSP), a video encoder, a modem, or other memory clients requesting read/write access to the memory system. The system 100 further comprises a high-level operating system (HLOS) 120.

The DRAM controller 114 controls the transfer of data over DDR bus 122. Cache 112 is a component that stores data so future requests for that data can be served faster. In an embodiment, cache 112 may comprise a multi-level hierarchy (e.g., L1 cache, L2 cache, etc.) with a last-level cache that is shared among the plurality of memory clients.

RPM 116 comprises various functional blocks for managing system resources, such as, for example, clocks, regulators, bus frequencies, etc. RPM 116 enables each component in the system 100 to vote for the state of system resources. As known in the art, RPM 116 may comprise a central resource manager configured to manage data related to the processing cores 106, 108, and 110. In an embodiment, RPM 116 may maintain a list of the types of processing cores 106, 108, and 110, as well as the operating frequency, temperature, and leakage of each core. As described below in more detail, RPM 116 may also update a stall time duration and/or percentage (e.g., a moving average) of each core. For each core, RPM 116 may collect a core stall time due to memory access and a core execution time. The core stall time and core execution times may be explicitly provided or estimated via one or more counters. For example, in an embodiment, cache miss counters associated with cache 112 may be used to estimate the core stall time.

RPM 116 may be configured to calculate a power/energy penalty overhead of stall duration per core. In an embodiment, the power/energy penalty overhead may be calculated by multiplying a power consumption during stall time by the stall duration. RPM 116 may calculate a total stall time power penalty (energy overhead) of all processing cores in the system 100. RPM 116 may be further configured to calculate the memory system power consumption for operating frequency level(s) for one level higher and lower than a current level. Based on this information, RPM 116 may determine whether the overall SOC power consumption (e.g., DRAM 104 and processing cores 106, 108, and 110) may be further reduced by increasing the memory operating frequency. In this regard, power reduction may be achieved by running DRAM 104 at a higher frequency and reducing stall time power overhead on the core side.

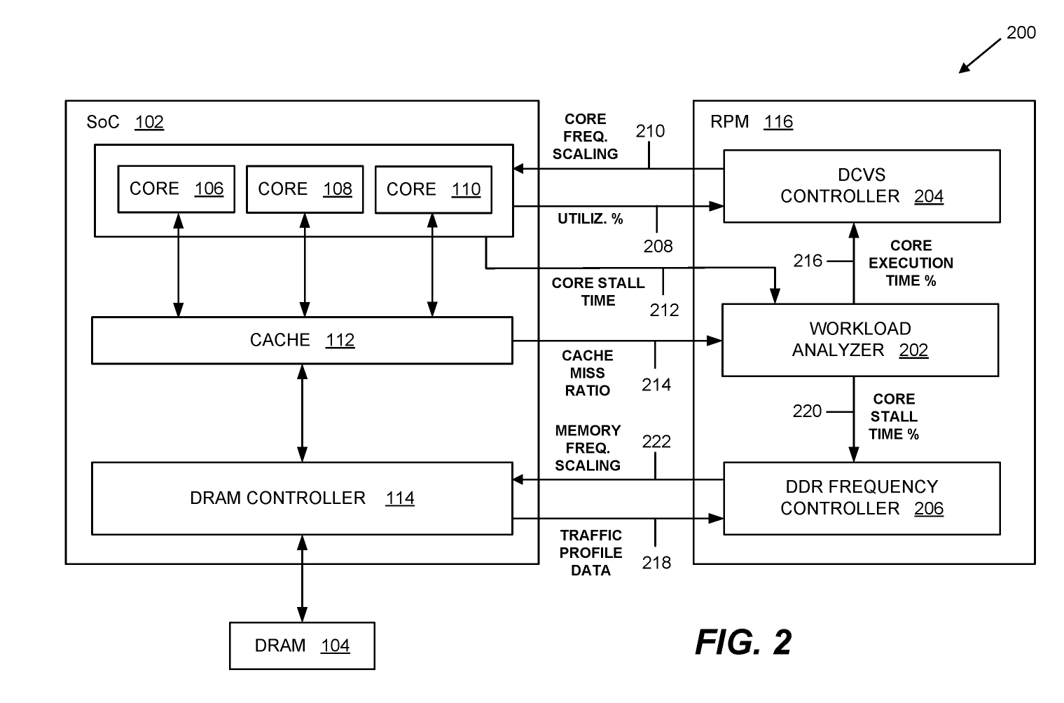

In the embodiment of FIG. 2, RPM 116 comprises a dynamic clock and voltage scaling (DCVS) controller 204, a workload analyzer 202, and a DDR frequency controller 206. DCVS controller 204 receives core utilization data (e.g., a utilization percentage) from each of the processing cores 106, 108, and 110 on an interface 208. The workload analyzer 202 receives core stall time data from each of the processing cores 106, 108, and 110 on an interface 212. The workload analyzer 202 may also receive cache miss ratio data from cache 112 on an interface 214. The workload analyzer 202 may calculate, for each of the processing cores 106, 108, and 110, a ratio of the core stall time versus the core execution time.

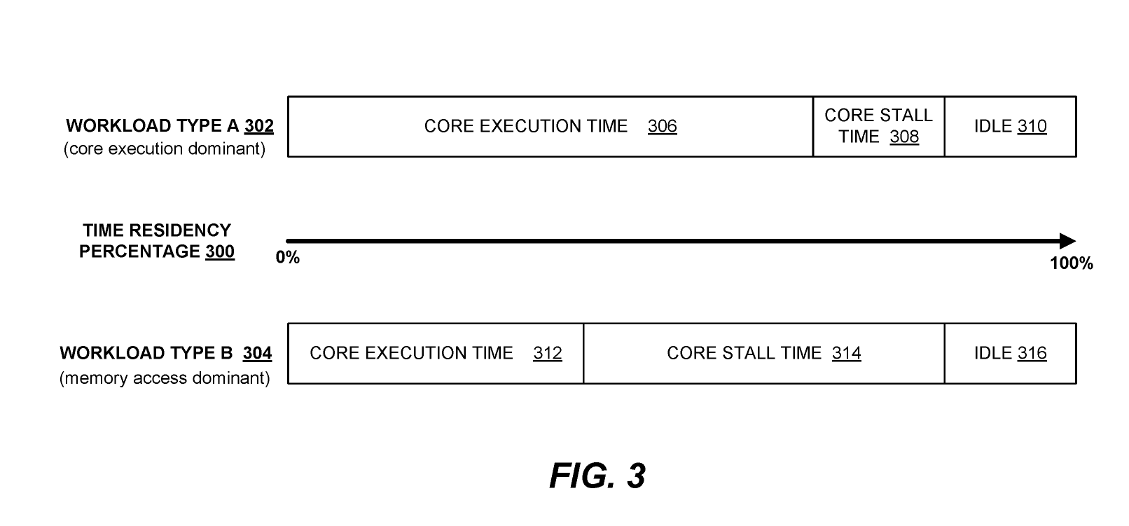

FIG. 3 illustrates two exemplary workload types with different ratios of core stall time versus execution time along a time residency percentage 300. A first workload type 302 comprises a core execution time (block 306) and a core stall time due to memory access latency (block 308). A second workload type 304 comprises a core execution time (block 312) and a core stall time due to memory access latency (block 314). Core idle times are illustrated at blocks 310 and 316 for the first and second workload types 302 and 304, respectively. As illustrated in FIG. 3, the first workload type 302 has a larger portion of total busy time for the core execution time 306 than the core stall time 308 (i.e., larger core execution time percentage), whereas the second workload type 304 has a larger portion of total busy time for the core stall time 314 than the core execution time 312 (i.e., larger core stall time percentage).

By receiving both the core stall time and the core execution time for each processing core, the workload analyzer 202 may distinguish workload tasks with a relatively larger stall time (e.g., workload type B 304) due to, for example, cache misses. In such cases, RPM 116 may maintain the current core frequency (or perhaps slightly increase the core frequency with minimal power penalty) while increasing the memory frequency to decrease the core stall time without degrading performance. As illustrated in FIG. 3, the workload analyzer 202 may provide a core execution time percentage to DCVS controller 204 on an interface 216. As known in the art, DCVS controller 204 may initiate core frequency scaling on interface 210 based on the core utilization percentage and/or the core execution time percentage. The workload analyzer 202 may provide the core stall time percentage on an interface 220 to the DDR frequency controller 206. In response to memory traffic profile data received on an interface 222, the DDR frequency controller 206 may initiate memory frequency scaling on an interface 222. In this manner, the system 100 uses the ratio of core stall time versus core execution time to enhance decisions regarding memory frequency control.

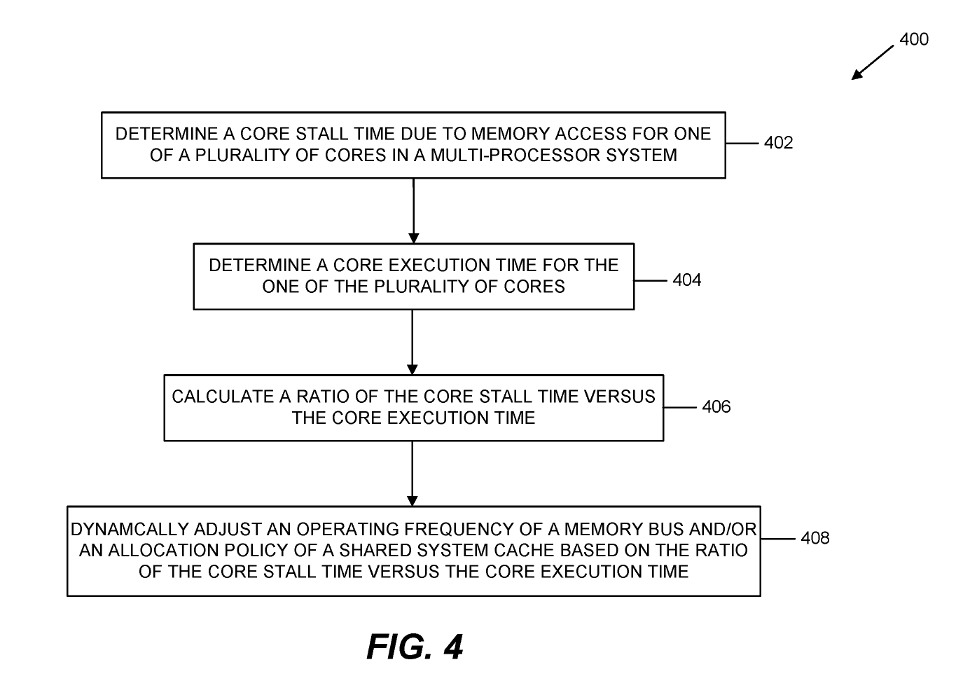

FIG. 4 is a flowchart illustrating an embodiment of a method 400 for implementing memory frequency control in the system 100. At block 402, for each of the processing cores 106, 108, and 110, a core stall time may be determined. As described above, the core stall time comprises the portion of workload busy time resulting from memory access. At block 404, the corresponding core execution time may be determined. It should be appreciated that the core stall time and the core execution time may be directly provided to the workload analyzer 202 and/or estimated based on counter(s). For example, a cache miss counter may be used to estimate the core stall time. At block 406, the ratio of the core stall time versus the core execution time may be calculated. Alternatively, the core stall time and the core execution time may be represented as a percentage of the total busy time for the task workload(s). At block 408, the DDR memory frequency controller may dynamically scale a frequency vote for the DDR bus 122 based on the calculated ratio or the core stall time percentage.

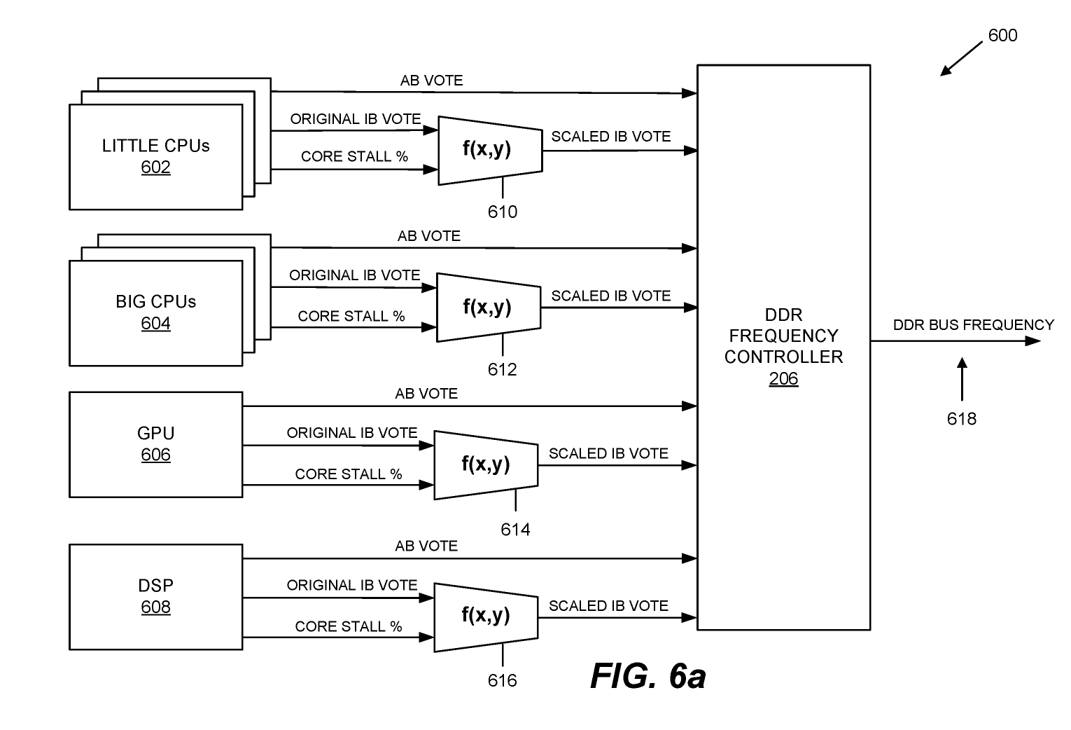

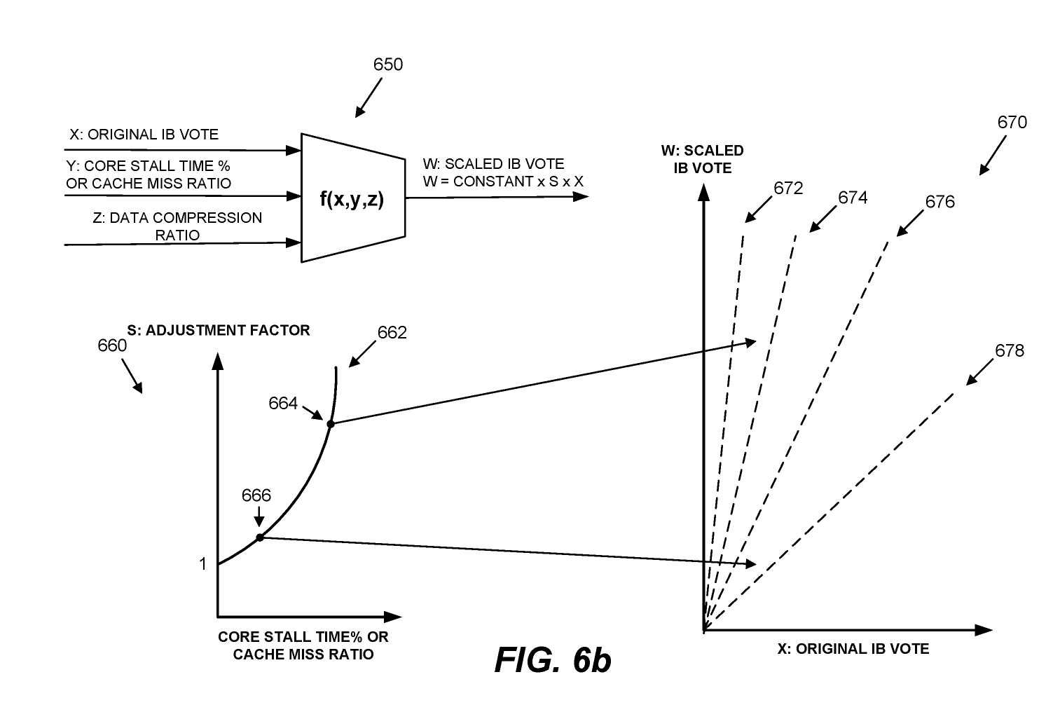

FIG. 6a illustrates an embodiment of a system 600 for dynamically scaling memory frequency voting in a heterogeneous processor cluster architecture, an example of which is referred to as a “big.LITTLE” heterogeneous architecture. The “big.LITTLE” and other heterogeneous architectures comprise a group of processor cores in which a set of relatively slower, lower-power processor cores are coupled with a set of relatively more powerful processor cores. For example, a set of processors or processor cores 604 with a higher performance ability are often referred to as the “Big cluster” while the other set of processors or processor cores 602 with minimum power consumption yet capable of delivering appropriate performance (but relatively less than that of the Big cluster) is referred to as the “Little cluster.” A cache controller may schedule tasks to be performed by the Big cluster or the Little cluster according to performance and/or power requirements, which may vary based on various use cases. The Big cluster may be used for situations in which higher performance is desirable (e.g., graphics, gaming, etc.), and the Little cluster may be used for relatively lower power user cases (e.g., text applications).

System 600 may also comprise other processing devices, such as, for example, a graphics processing unit (GPU) 606 and a digital signal processor (DSP) 608. Because performance and power penalty can vary depending on the core types, different scaling factors may be applied for different cores and/or clusters. Functional scaling blocks 610, 612, 614, and 616 may be used to dynamically scale an instantaneous memory bandwidth vote for Little CPUs 602, Big CPUs 604, GPU 606, and DSP 608, respectively. The “original IB votes” provided to blocks 610, 612, 614, and 616 comprise original instantaneous votes (e.g., in units of Mbyte/sec). It should be appreciated that an original instantaneous vote represents the amount of peak read/write traffic that the core (or other processing device) may generate over a predetermined short time duration (e.g., tens of or hundreds of nano-seconds). Each scaling block may be configured with a dedicated scaling factor matched to the corresponding processing device. Functional scaling blocks 610, 612, 614, and 616 up/down scale the original instantaneous bandwidth vote to a higher or lower value depending on the core stall percentage. In an embodiment, the scaling may be implemented via a simple multiplication or look-up table or mathematical conversion function. The outputs of the functional scaling blocks 610, 612, 614, and 616 are provided to the DDR frequency controller 206 along with, for example, corresponding average bandwidth votes. As further illustrated in FIG. 6a, the “AB votes” comprise an average bandwidth vote (e.g., in units of Mbyte/sec). An AB vote represents the amount of average read/write traffic that the core (or other processing device) is generating over a predetermined relatively longer time duration than the IB vote (e.g., several seconds). The DDR frequency controller 206 provides frequency outputs 618 to the DDR bus 122.

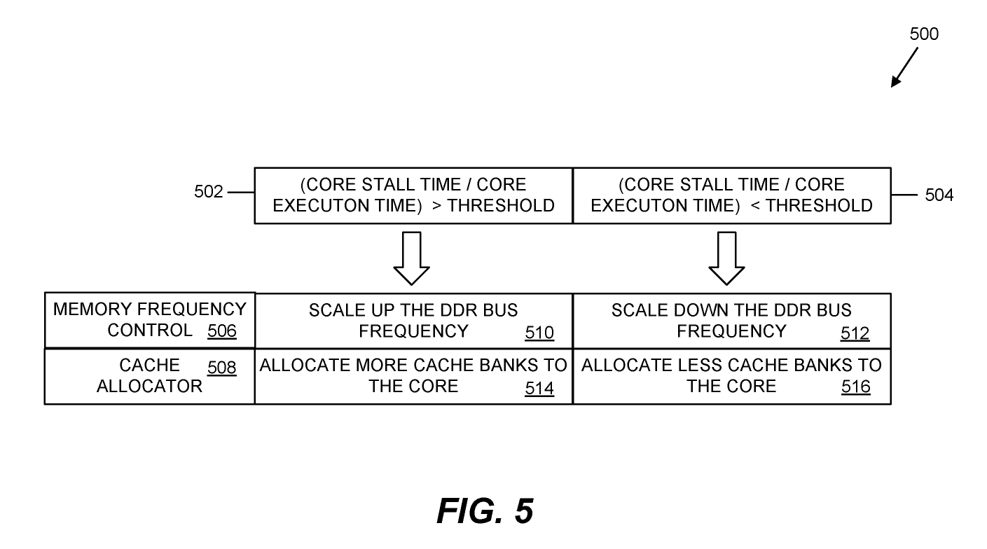

It should be appreciated that the information regarding the core stall time versus the core execution time may be used to enhance various system controls (e.g., core DCVS, memory frequency control, big.LITTLE scheduling, and cache allocation). FIG. 5 illustrates exemplary control actions that may be executed based on the ratio of the core stall time versus the core execution time. If the ratio exceeds a predetermined or calculated threshold value (block 502), a memory frequency control 506 may scale up the DDR bus frequency (block 510). A cache allocator 508 may allocate more cache banks to the corresponding processing core. If the ratio is below a predetermined or calculated threshold value (block 504), the memory frequency control 506 may scale down the DDR bus frequency (block 512). The cache allocator 508 may allocate fewer cache banks to the corresponding processing core (block 516).

FIG. 6b illustrates another embodiment of a functional scaling block 650. As illustrated in FIG. 6b, the functional scaling block 650 may receive inputs X, Y, and Z. Input X comprises an original IB vote. Input Y comprises a core stall time percentage or cache miss ratio. Input Z may comprise any other factors, such as, for example, a data compression ratio when a memory bandwidth compression feature is enabled by the system 100. The functional scaling block 650 outputs a scaled IB vote (W) having a value equal to the product of a constant (C), an adjustment factor (S), and the input X. Graphs 660 and 670 in FIG. 6b illustrate an embodiment for dynamically scaling memory frequency voting via the functional scaling block 650. Graph 660 illustrates an exemplary adjustment factor (S) according to the following equation:

S=[100%]/(100%−core stall time %) Equation 1

Graph 670 illustrates corresponding values (lines 672, 674, 676, and 678) for the scaled IB vote (W) along the line 662 in graph 660. Point 664 in graph 660 corresponds to line 674 in graph 670. Point 666 in graph 660 corresponds to line 678 in graph 670. As illustrated, line 674 is steeper than line 678. One of ordinary skill in the art will appreciate that line 674 may represent the case in which there is a relatively large core stall time percentage and a higher DRAM frequency is desired. Line 678 may represent the case in which there is a relatively smaller core stall time percentage and a lower DRAM frequency is desired. In this regard, the functional scaling block 650 may dynamically adjust the memory frequency between the lines illustrated in graph 670.

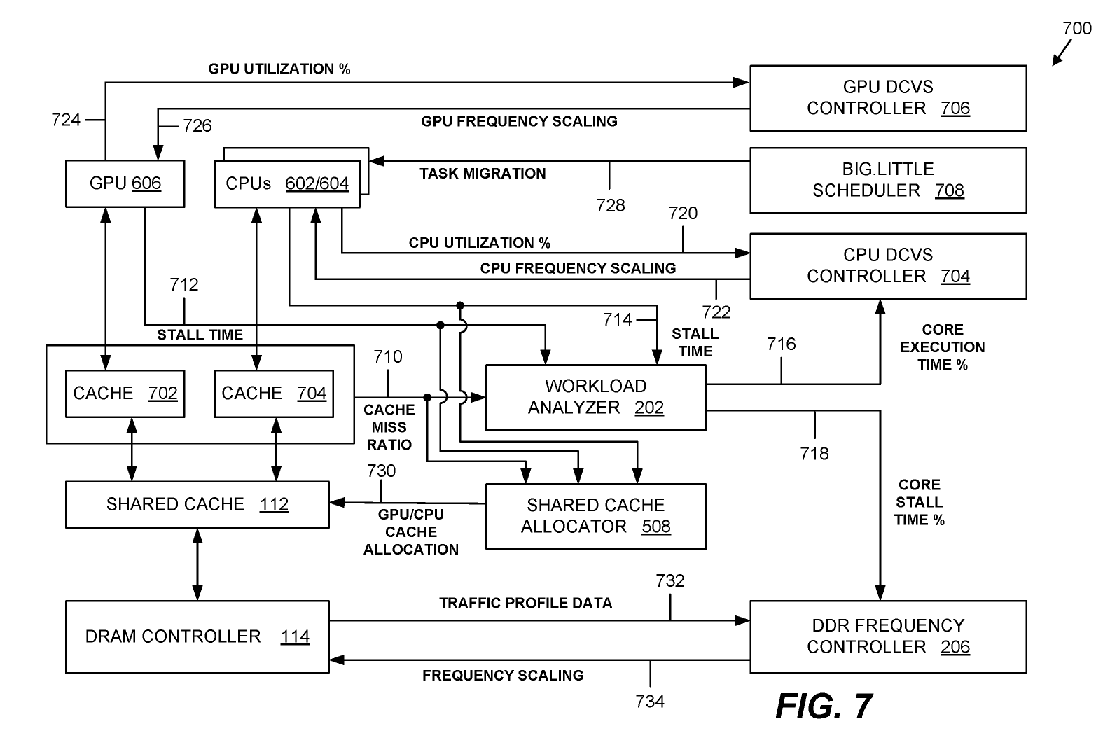

FIG. 7 illustrates another embodiment of a system 700 for dynamically scaling memory frequency voting. System 700 has a multi-level cache structure comprising shared cache 112 and dedicated cache 702 and 704 for GPU 606 and CPUs 602/604, respectively. System 700 further comprises a GPU DCVS controller 706, a CPU DCVS controller 704, and a big.Little scheduler 708. GPU DCVS controller 706 receives GPU utilization data (e.g., a utilization percentage) from GPU 606 on an interface 724. CPU DCVS controller 706 receives CPU utilization data (e.g., a utilization percentage) from CPUs 602/604 on an interface 720.

The workload analyzer 202 receives core stall time data from GPU 606 on an interface 712. The workload analyzer 202 receives core stall time data from CPUs 602/604 on an interface 714. The workload analyzer 202 may also receive cache miss ratio data from dedicate cache 702 and 704 on an interface 710. The workload analyzer 202 may calculate core execution time percentages and core stall time percentages for GPU 606 and CPUs 602/604. As further illustrated in FIG. 7, the workload analyzer 202 may provide core execution time percentages to CPU DCVS controller 704 on an interface 716. As known in the art, CPU DCVS controller 704 may initiate CPU frequency scaling on interface 722 based on the core utilization percentage and/or the core execution time percentage. GPU DCVS controller 706 may initiate GPU frequency scaling on interface 726 based on the core utilization percentage and/or the core execution time percentage. Big.Little scheduler 708 may perform task migration between the Big cluster and the Little cluster via interface 728.

The workload analyzer 202 may provide the core stall time percentage on an interface 718 to the DDR frequency controller 206. In response to memory traffic profile data received on an interface 732, the DDR frequency controller 206 may initiate memory frequency scaling on an interface 734. The shared cache allocator 508 may interface with the workload analyzer 202 and, based on the ratio of core stall time versus core execution time may allocate more or less cache to the GPU 606 and/or the CPUs 602/604.

One of ordinary skill in the art will readily appreciate that the scheme(s) described for dynamically scaling memory frequency may be further extended and/or applied in alternative embodiments, such as, for example, for a plurality of heterogeneous cores such as a modem core, a DSP core, a video codec core, a camera core, an audio codec core, and a display processor core.

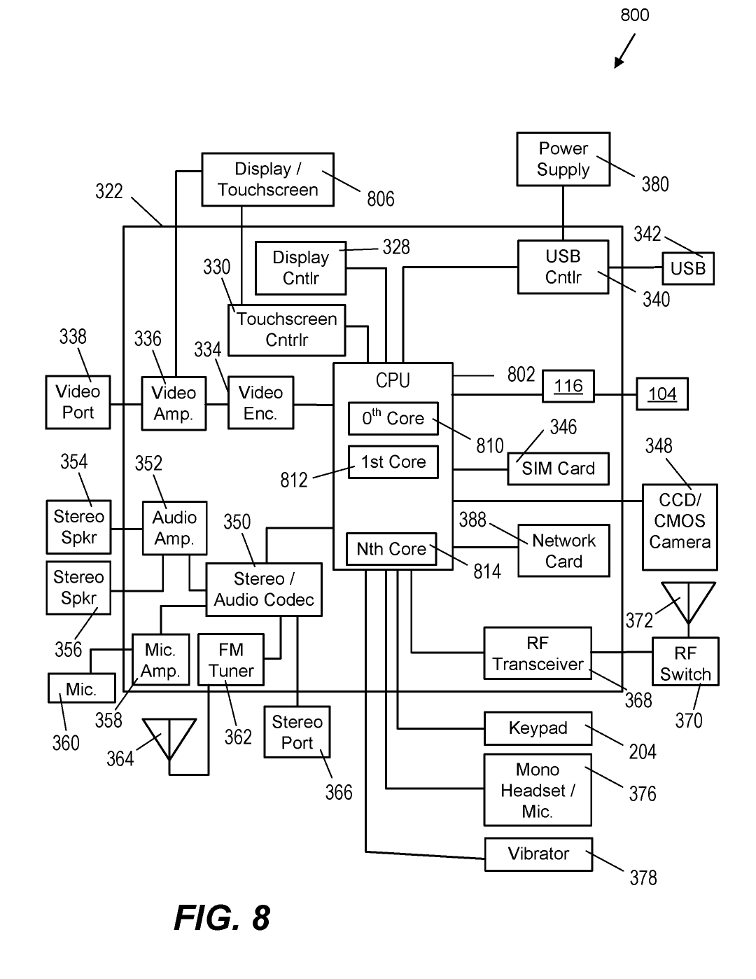

As mentioned above, the system 100 may be incorporated into any desirable computing system. FIG. 8 illustrates the system 100 incorporated in an exemplary portable computing device (PCD) 800. It will be readily appreciated that certain components of the system 100 (e.g., RPM 116) are included on the SoC 322 (FIG. 8) while other components (e.g., the DRAM 104) are external components coupled to the SoC 322. The SoC 322 may include a multicore CPU 802. The multicore CPU 802 may include a zeroth core 810, a first core 812, and an Nth core 814. One of the cores may comprise, for example, a graphics processing unit (GPU) with one or more of the others comprising the CPU.

A display controller 328 and a touch screen controller 330 may be coupled to the CPU 802. In turn, the touch screen display 606 external to the on-chip system 322 may be coupled to the display controller 328 and the touch screen controller 330.

FIG. 8 further shows that a video encoder 334, e.g., a phase alternating line (PAL) encoder, a sequential color a memoire (SECAM) encoder, or a national television system(s) committee (NTSC) encoder, is coupled to the multicore CPU 802. Further, a video amplifier 336 is coupled to the video encoder 334 and the touch screen display 806. Also, a video port 338 is coupled to the video amplifier 336. As shown in FIG. 8, a universal serial bus (USB) controller 340 is coupled to the multicore CPU 802. Also, a USB port 342 is coupled to the USB controller 340. Memory 104 and a subscriber identity module (SIM) card 346 may also be coupled to the multicore CPU 802.

Further, as shown in FIG. 8, a digital camera 348 may be coupled to the multicore CPU 802. In an exemplary aspect, the digital camera 348 is a charge-coupled device (CCD) camera or a complementary metal-oxide semiconductor (CMOS) camera.

As further illustrated in FIG. 8, a stereo audio coder-decoder (CODEC) 350 may be coupled to the multicore CPU 802. Moreover, an audio amplifier 352 may be coupled to the stereo audio CODEC 350. In an exemplary aspect, a first stereo speaker 354 and a second stereo speaker 356 are coupled to the audio amplifier 352. FIG. 8 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 8 further illustrates that a radio frequency (RF) transceiver 368 may be coupled to the multicore CPU 802. An RF switch 370 may be coupled to the RF transceiver 368 and an RF antenna 372. A keypad 204 may be coupled to the multicore CPU 802. Also, a mono headset with a microphone 376 may be coupled to the multicore CPU 802. Further, a vibrator device 378 may be coupled to the multicore CPU 802.

FIG. 8 also shows that a power supply 380 may be coupled to the on-chip system 322. In a particular aspect, the power supply 380 is a direct current (DC) power supply that provides power to the various components of the PCD 800 that require power. Further, in a particular aspect, the power supply is a rechargeable DC battery or a DC power supply that is derived from an alternating current (AC) to DC transformer that is connected to an AC power source.

FIG. 8 further indicates that the PCD 800 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, a television/cable/satellite tuner, or any other network card well known in the art. Further, the network card 388 may be incorporated into a chip, i.e., the network card 388 may be a full solution in a chip, and may not be a separate network card 388.

As depicted in FIG. 8, the touch screen display 806, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 may be external to the on-chip system 322.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for controlling power efficiency in a multi-processor system, the method comprising:
determining a core stall time due to memory access for one of a plurality of cores in a multi-processor system;
determining a core execution time for the one of the plurality of cores;
calculating a ratio of the core stall time versus the core execution time; and
dynamically scaling a frequency vote for a memory bus based on the ratio of the core stall time versus the core execution time.

2. The method of claim 1, wherein the dynamically scaling the frequency vote comprises scaling up the frequency vote for the memory bus.

3. The method of claim 1, wherein the dynamically scaling the frequency vote comprises scaling down the frequency vote for the memory bus.

4. The method of claim 1, wherein the core stall time is measured or estimated based on a cache miss counter.

5. The method of claim 1, wherein the multi-processor system comprises a big.LITTLE architecture.

6. The method of claim 1, wherein the multi-processor system resides on a system on chip (SoC) electrically coupled to a memory device via the memory bus.

7. The method of claim 1, further comprising:
adjusting allocation of a shared system cache based on the ratio of the core stall time versus the core execution time.

8. The method of claim 1, further comprising:
adjusting the frequency vote for the memory bus based on a bandwidth compression rate.

9. A system for controlling power efficiency in a multi-processor system, the system comprising:
means for determining a core stall time due to memory access for one of a plurality of cores in a multi-processor system;
means for determining a core execution time for the one of the plurality of cores;
means for calculating a ratio of the core stall time versus the core execution time; and
means for dynamically scaling a frequency vote for a memory bus based on the ratio of the core stall time versus the core execution time.

10. The system of claim 9, wherein the means for dynamically scaling the frequency vote comprises: means for scaling up the frequency vote for the memory bus.

11. The system of claim 9, wherein the means for dynamically scaling the frequency vote comprises: means for scaling down the frequency vote for the memory bus.

12. The system of claim 9, wherein the means for determining the core stall time comprises one of a means for measuring the core stall time and a means for estimating the core stall time based on a cache miss rate.

13. The system of claim 9, wherein the multi-processor system comprises a big.LITTLE architecture.

14. The system of claim 9, wherein the multi-processor system resides on a system on chip (SoC) electrically coupled to a memory device via the memory bus.

15. The system of claim 9, further comprising:
means for adjusting allocation of a shared system cached based on the ratio of the core stall time versus the core execution time.

16. The system of claim 9, further comprising:
means for adjusting the frequency vote for the memory bus based on a bandwidth compression rate.

17. A computer program embodied in a memory and executable by a processor for implementing a method for controlling power efficiency in a multi-processor system, the method comprising:
determining a core stall time due to memory access for one of a plurality of cores in a multi-processor system;
determining a core execution time for the one of the plurality of cores;
calculating a ratio of the core stall time versus the core execution time; and
dynamically scaling a frequency vote for a memory bus based on the ratio of the core stall time versus the core execution time.

18. The computer program of claim 17, wherein the dynamically scaling the frequency vote comprises scaling up the frequency vote for the memory bus.

19. The computer program of claim 17, wherein the dynamically scaling the frequency vote comprises scaling down the frequency vote for the memory bus.

20. The computer program of claim 17, wherein the core stall time is measured or estimated based on a cache miss counter.

21. The computer program of claim 17, wherein the multi-processor system comprises a big.LITTLE architecture.

22. The computer program of claim 17, wherein the multi-processor system resides on a system on chip (SoC) electrically coupled to a memory device via the memory bus.

23. The computer program of claim 17, wherein the method further comprises:
adjusting allocation of a shared system cache based on the ratio of the core stall time versus the core execution time.

24. The computer program of claim 17, wherein the method further comprises:
adjusting the frequency vote for the memory bus based on a bandwidth compression rate.

25. A system for controlling power efficiency in a multi-processor system, the system comprising:
a dynamic random access memory (DRAM); and
a system on chip (SoC) electrically coupled to the DRAM via a double data rate (DDR) bus, the SoC comprising:
a plurality of processing cores;
a cache; and
a DDR frequency controller configured to dynamically scale a frequency vote for the DDR bus based on a calculated ratio of a core stall time versus a core execution time for one of the plurality of processing cores.

26. The system of claim 25, wherein the dynamically scaling the frequency vote comprises scaling up the frequency vote for the memory bus.

27. The system of claim 25, wherein the dynamically scaling the frequency vote comprises scaling down the frequency vote for the memory bus.

28. The system of claim 25, wherein the core stall time is measured or estimated based on a cache miss counter.

29. The system of claim 25, wherein the plurality of processing cores comprises a big.LITTLE architecture.

30. The system of claim 25 incorporated in a portable communication device.
